(19) United States
(12) Patent Application Publication
(10) Pub. No.: US 2003/0083965 A1
(43) Pub. Date: May 1, 2003

(54) System and method for determining taxes for equipment contracts

(76) Inventor: William E. Taylor, Franklin, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/016,385

(22) Filed: Oct. 26, 2001

(51) Int. Cl. G06F 17/60

(52) U.S. Cl. 705/31

(57) ABSTRACT

A computer based system and method automatically determines taxes for a contract for equipment. A set of contract characteristics and customer location information is input by a user. The appropriate set of tax rules to apply are determined as a function of the customer location information a contract type based on the contract characteristics under the set of tax rules is determined and a tax amount is calculated based on the contract characteristics, the contract type and the set of tax rules.

### TECHNICAL FIELD

The present invention relates generally to the sale and leasing of equipment, and more particularly, to a computer based system and method for automatically determining the taxes for equipment contracts.

### BACKGROUND

The purchase or lease of equipment, such as construction or agricultural equipment, engines, etc., is a very detailed process involving complicated financing decisions and financial documents. The process involves determining the type of financing available for the customer, as well as geographic factors. Additionally, depending on the type of financing and the geographic location of the customer, the number, type, as well as the terms of, the documents required vary.

In a typical sale or lease, the first step includes a quoting process. The quoting process involves a discussion with the customer, generally, including determining the equipment which the customer desires to lease or purchase and type and size of desired payment.

The second step is the credit process. The credit process involves requesting and receiving the customer credit scoring from a credit bureau. The credit scoring are used to determine the type of financing available to the customer. Other factors, may also be used to determine the type of financing available, such as the customer's payment history on past purchases or leases.

Once the financing terms have been arranged, the financing documents must be prepared. As discussed above, the number and type of documents, as well as specific clauses or terms in the financing documents will vary. Factors includes customer, the lessor, the geographic location, and the type of financing.

Historically, the financing documents were manually prepared by a finance analyst for each transaction. This manual process is time consuming and expensive. More recently, a computer program application has been developed which uses the information gathered during the quoting and credit processes, as well as information from other destinations or sources, in order to automatically prepare the list of financing documents. From the automatically prepared list, the automated remote documents computer system returns the documents.

After the formal contract documents have been prepared the determination of the applicable taxes must be completed. The calculation of sales and use taxes for equipment leases is dependent upon many variables. The variables are dependent on factors such as the structure of the lease, the location of the equipment, etc. . . . In addition to the amount of sales and use taxes owed, proper analysis is needed to determine who is responsible for the taxes, and the due date for the taxes.

Traditionally, this analysis is generally completed by clerks. Their analysis is based on information received from the customer as well as the tax rules applicable to the particular location. The high volume of analyses a clerk must perform results in a high potential for errors in the collection of the sale and/or use taxes. These errors may lead to customer complaints and audit assessments.

Several systems are currently available that electronically determine tax rates using limited tax logic. However, these systems are generally simple tax calculation systems based on the location in which a sale took place. These systems do not take into consideration an analysis of the type of lease in determining the appropriate taxes.

The present invention is aimed at one or more of the problems discussed above.

### SUMMARY OF THE INVENTION

In one embodiment of the present invention, a computer based system for automatically determining taxes for a contract for equipment is provided. The system includes a database for storing a set of state and local tax rules and a controller coupled to the database. The controller is adapted to receive a set of contract characteristics and the customer location information input by a user and automatically determine an appropriate set of state and local tax rules to apply as a function of the customer location information. The controller is also adapted to determine a contract type based on the contract characteristics under the set of state and local tax rules and to calculate a tax amount based on the contract characteristics.

In another embodiment of the present invention, a computer based method for automatically determining taxes for a contract for equipment, is provided. The method includes the steps establishing a set of contract characteristics, establishing customer location information; and automatically determining an appropriate set of state and local tax rules to apply as a function of the customer location information. The method also includes the steps of determining a contract type based on the contract characteristics under the set of state and local tax rules and calculating a tax amount based on the contract characteristics, the contract type and the set of state and local tax rules.

### BRIEF DESCRIPTION OF DRAWINGS

FIG. 1 is a flow diagram of a transaction process including a tax determination process, according to an embodiment of the present invention;

FIG. 2 is a block diagram of a system for automatically determining taxes for a contract for equipment;

FIG. 3 is a block diagram of a computer program product for automatically determining taxes for a contract for equipment, according to an embodiment of the present invention; and,

FIG. 4 is a first flow diagram of a method for automatically determining taxes for a contract for equipment, according to an embodiment of the present invention.

### DETAILED DESCRIPTION

With reference to the drawings, and in operation, the present invention provides a computer based system 200 and a method 400 for automatically determining taxes for equipment leases, such as agricultural or construction equipment, engines, or any equipment or item which may be leased.

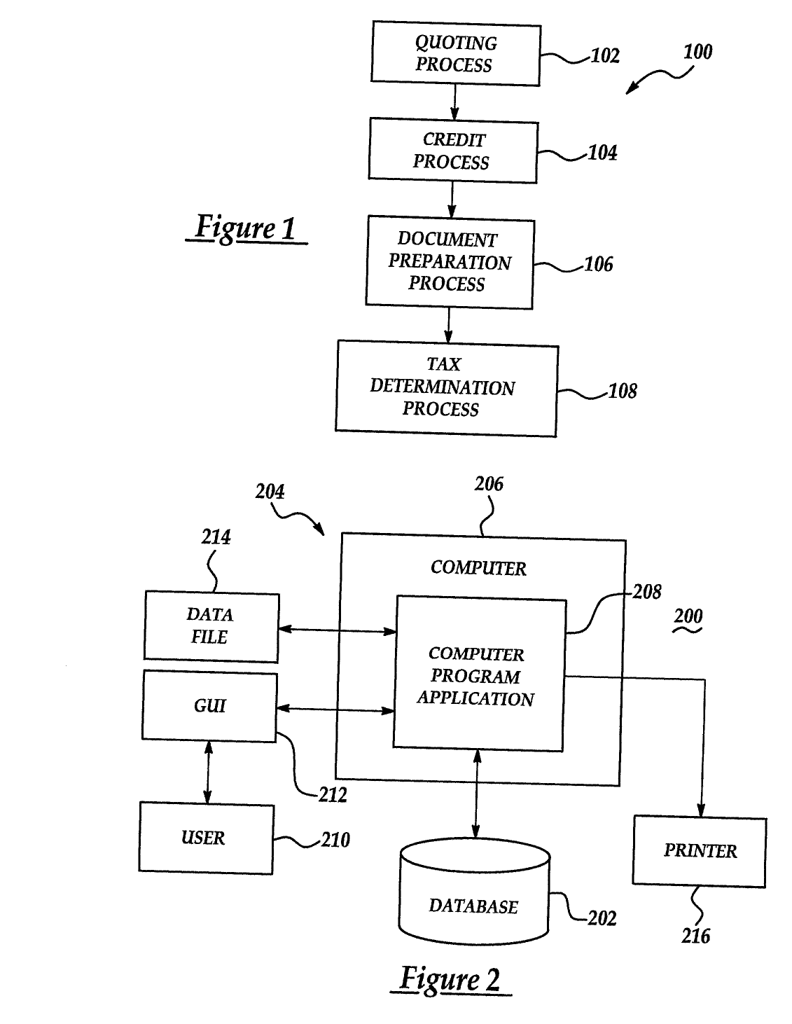

With specific reference to FIG. 1, the present invention may be utilized during the creation of a purchasing or leasing transaction 100 for equipment. As described above, the creation process includes: a quoting process (flow block 102), a credit process (flow block 104), a document preparation process (flow block 106), and a tax determination process (flow block 108).

Generally, a customer desires to purchase or lease one or more pieces of equipment. The customer contacts a sales agent, who may be located at either a dealer of the equipment or at a financing company. Alternatively, the customer may interact with a user interface implemented on a computer network, e.g., a website on the internet.

In the quoting process 102, the agent works with the customer and determines the equipment which the customer wished to purchase or lease and the maximum monthly payment the customer desires.

In the credit process 104, the sales agent requests a credit scoring for the customer from a credit bureau. This information, along with other information regarding the customer's history with the financing company, is used to determine whether to extend credit to the customer for the purchase or lease of the equipment and, if so, under what terms.

During the quoting and credit processes 102, 104, the sales agent requests and receives from the customer, transaction information. As described below, the agent enters this information into the system 200.

With specific reference to FIG. 2, the computer system 200 for automatically determining taxes for equipment contracts, according to an embodiment of the present invention, will now be described.

The system 200 includes a database 202 for storing a set of state and local tax rules and a controller 204 coupled to the database 202. The controller 204 is adapted to run a computer program application 208 in a conventional manner (see below). In one embodiment, the controller 204 is a stand alone computer 206 operable by a user 210 through a graphical user interface (GUI) 212.

In another embodiment, the computer 206 is part of a computer network (not shown), such as the internet. The GUI 212 may be run on a second computer (not shown) connected to the network. The GUI 212 may be is implemented via a web enabled browser computer program, such as, Microsoft Internet Explorer.

The computer program application 208 is adapted to receive a set of contract characteristics and the customer location information input by the user 210 and automatically determine an appropriate set of state or local tax rules to apply as a function of either the customer location information, the contract characteristics, and/or contract type. In other words, based on the user's input data, the computer program application 208 retrieves the appropriate set of state and local tax rules from the database 202. Preferably, the customer location information includes a zip code.

The user 210 may input the set of contract characteristics and customer location information to the system 200 through the GUI 212. Alternatively, the set of contract characteristics, contract type, and customer location information may be entered into the system 200 through a data file 214.

The computer program application 208 is further adapted to determine a contract type based on the contract characteristics under the set of state and local tax rules and to calculate a tax amount based on the contract characteristics, the contract type and the set of state and local tax rules.

In one embodiment, the contract type is one of a lease and a financing contract. In another embodiment, the contract type is one of an operating lease, a true lease, a finance option lease, a finance lease purchase with mandatory final payment, a government lease purchase and an installment sale.

These terms are generally defined below. However, each state may define the terms differently. For a particular set of state and local tax rules, the jurisdictional definitions will be applied.

Operating Lease are leases for both book and tax purposes. The FAS-13 rules are applied to the lease. The FAS-13 rules include a four item test. If the contract does not pass any of the four tests then it will be considered an operating lease. The FAS-13 rules are similar but generally more difficult to pass than ths IRS' tax rules. Therefore, if the lease passes the FAS-13 rules, then normally the lease will pass the IRS rules. Under an operating lease, the lessor has ownership of the asset for both book and tax purposes. The lessee or customer is simply paying for the use of the asset and has no equity built up in the asset. The four items are:

the lease period is more than 75% of the economic life of the asset

the payments are more than 90% of the NPV of the asset

there is an automatic transfer of the asset at the end of the lease; and

the lease contains a bargain purchase option.

True Lease (or tax lease) are leases in which there is no equity built up by the customer in the equipment. In general, if there is equity built up, then the customer may be buying the equipment, as opposed to leasing it. If the agreement or contract is structured such that the customer is buying the equipment, then the lessor does not get to declare the depreciation of the equipment. If the lease is a true lease, then the financing company will not own the equipment for book purposes, but will be the owner for tax purposes. For example, under a true lease, the financing company would be able to declare accelerated depreciation for Federal and State income tax purposes. However, this would not affect the determination of the state's sales tax since each state's sales tax rules are independent of the income tax rules.

Finance Option Lease: Under a finance option lease, the financing company is not the owner of the equipment. The customer builds up equity in the equipment during the course of the lease. The customer may have a bargain option for the purchase of the equipment at the end of the lease and have accumulated equity in the equipment at that time. Therefore, the lessee may normally take the depreciation in the equipment.

Finance Lease Purchase with Mandatory Final Payment: If there is a mandatory final payment, the lease is normally a sake and the lessee can take the depreciation for Federal Tax purposes. Thus, the lease is not a lease for Federal purposes. For sales tax purposes, ownership will again be considered under the relevant state rules.

Government Lease Purchase: Government lease purchases have most of the sane characteristics as the Finance Lease contract. The main differences are related to the tax language in the contract. There cannot be an option at the end of the contract, but there can be a balloon payment up to 80% of the fair market value of the equipment at the end of the contract. In addition, a government lease purchase can only be offered to tax exempt entities, not including federal government agencies.

Installment Sales—Dealer Equipment: The financing company buys the contract, not the equipment. Thus, the customer and the dealer are responsible for the sales and/or use taxes.

Installment Sales—Financing Company Equipment: The financing company owns the equipment and is therefore responsible for the sale and/or use taxes.

The set of state and local tax rules may include exemption and/or partial exemption rules includes special state and/or local rulings, e.g., a related to a power output (typically in terms of horsepower) and or the type of equipment. The type of equipment could include a product family, e.g., backhoe loader and/or a model number, e.g., 420.

In a further embodiment, the controller 204 is adapted to determine a paying party who will pay the tax amount as a function of the set of state and local rules. The paying party is the dealer, the financing company or the customer. The controller 204 also determines how the tax is to be paid, e.g., upfront or with a stream of payments as a function of the set of state and local tax rules.

The state and local tax rules stored in the database 202 includes maximum and double tax rules. The determination of the taxes due take into account the maximum and double tax rules. In one embodiment, the database 200 includes rules for each locality's sales, use, rental and personal property taxes. Alternatively, the database 200 is configured to access the appropriate rules and regardless of the location of the rules.

In one embodiment, the controller 204 is adapted to generate or print an invoice for the tax amount using, e.g., a printer 216.

The set of contract characteristics may include, but is not limited to:

a residual amount due at end of contract,

a purchase price of the equipment,

a type of purchase option,

a mandatory final payment, and/or

a trade-in.

The type of purchase option may be one of fair market value, a CVO, a bargained price, and/or none.

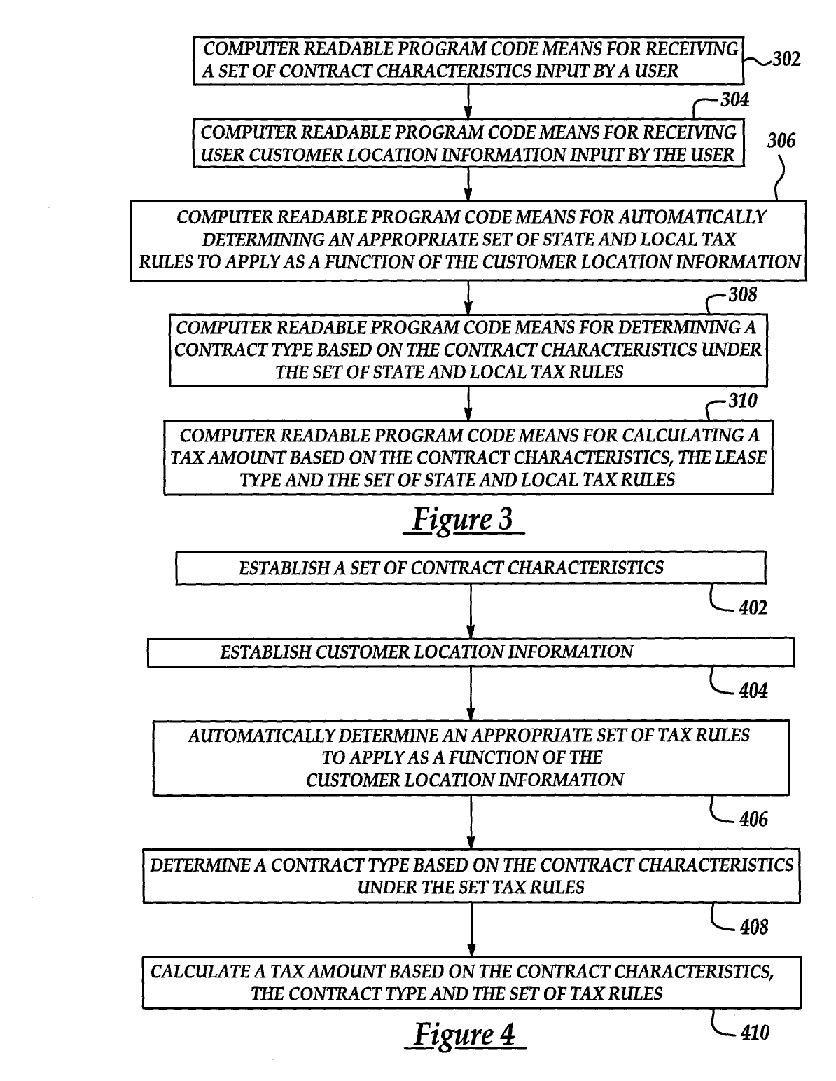

With reference to FIG. 3, a computer program product 300 may automatically create a list of financing documents for a transaction. The computer program product 300 includes computer readable program code means 302 for receiving a set of contract characteristics input by a user and computer readable program code means 304 for receiving customer location information input by the user. The computer program product 300 also includes computer readable program code means 306 for automatically determining an appropriate set of state and local tax rules to apply as a function of the customer location information and computer readable program code means 308 for determining a contract type based on the contract characteristics under the set of state and local tax rules. The computer program product 300 further includes computer readable program code means 310 for calculating a tax amount based on the contract characteristics, the contract type and the set of state and local tax rules.

With reference to FIG. 4, a computer based method 400 for automatically determining taxes for a contract for equipment will now be discussed. In a first process block 402, a set of contract characteristics are established. In a second process block 404, customer location information is established. In one embodiment, the customer location information may include a zip code. The set of contract characteristics and the customer location information may by input by the user 210.

In a third process block 406, an appropriate set of state and/or local tax rules are determined and retrieved from the data base 202 as a function of the customer location information. Local tax rules may include country rules. In a fourth process block 408, a contract type is determined based on the contract characteristics under the set of state and local tax rules.

In a fifth process block 410, a tax amount is calculated based on the contract characteristics, the contract type and the set of state and local tax rules.

In one embodiment, the contract type is one of a lease and a financing contract. In another embodiment, the contract type is one of an operating lease, a true lease, a finance option lease, a finance lease purchase with mandatory final payment, a government lease purchase and an installment sale.

Preferably, the set of state and local tax rules include exemption and/or partial exemption rules and special state and/or local rulings. In one embodiment, the paying party may be the manufacturer of the equipment.

In one embodiment, the method 400 includes the step of determining a paying party who will pay the tax amount as a function of the set of state and local rules. The paying party is either the dealer, the financing company or the customer. Alternatively, the customer may interact with a user interface implemented on a computer network e.g., a website on the internet.

In one embodiment, the method 400 includes the step of determining how the tax amount is to paid, e.g., upfront or in a stream of payments.

In one embodiment, the method 400 includes the step of automatically generating an invoice for the tax amount.

### INDUSTRIAL APPLICABILITY

With specific reference to FIG. 1, the present invention provides a system and method 200, 400 for automatically determining taxes for an equipment contract. The system and method 200, 400, in practice, are generally part of a sale or lease transaction for, e.g., equipment. The customer (purchaser or lessee) interacts with an employee (sales agent) of a dealer, a financing company or the manufacturer.

As described above, there are generally four steps to the transaction: the quoting process, the credit process, the document preparation process, and the tax determination process.

In the quoting process, the customer and the sales agent discuss the type and number of equipment, the type of contract, and the maximum size payment the client desires. After these are determined, the agent performs a credit check on the customer to determine whether or not to extend the desired credit to the customer. Past customer conduct with respect to payment history to the financing company may also be considered. After the credit process, the transaction documents needs to be prepared. This may be done automatically using an auto-packaging computer application for generating a list of the required documents using information gathered during the quoting process and the credit process and a remote docs computer application (not shown) for preparing the documents. Alternatively, the required documents could be manually assembled.

Using the information provided during the above described process, the present invention is used to automatically determine the taxes due, including the type and the amount, and which party is responsible for paying the taxes as a function of the state and/or local, e.g., country, tax rules which are applicable to the customer. The state and local tax rules are retrieved from the database 202 as a function of the customer location information.

Other aspect and features of the present invention can be obtained from a study of the drawings, the disclosure, and the appended claims.

What is claimed is:

1. A computer based method for automatically determining taxes for a contract for equipment, including the steps of:
establishing a set of contract characteristics;
establishing customer location information;
automatically determining an appropriate set of tax rules to apply as a function of the customer location information;
determining a contract type based on the contract characteristics under the set of tax rules; and,
calculating a tax amount based on the contract characteristics, the contract type, and the set of tax rules.

2. A computer based method, as set forth in claim 1, wherein the contract type is one of a lease and a financing contract.

3. A computer based method, as set forth in claim 1, wherein the contract type is one of an operating lease, a true lease, a finance option lease, a finance lease purchase with mandatory final payment, a government lease purchase and an installment sale.

4. A computer based method, as set forth in claim 1, wherein the set of tax rules include state and local tax rules.

5. A computer based method, as set forth in claim 4, wherein the set of state and local tax rules include special state and/or local rulings.

6. A computer based method, as set forth in claim 5, wherein the special state and/or local rulings are a function of a power output of the equipment.

7. A computer based method, as set forth in claim 5, wherein the special state and local tax rules are a function of the equipment.

8. A computer based method, as set forth in claim 1, further including the step of determining a paying party who will pay the tax amount as a function of the set of tax rules.

9. A computer based method, as set forth in claim 8, wherein the paying party is one of a dealer, a financing company and a customer.

10. A computer based method, as set forth in claim 1, including the step of determining how the tax amount is to be paid.

11. A computer based method, as set forth in claim 10, wherein the tax amount is to be paid up front or in a series of payments.

12. A computer based method, as set forth in claim 1, wherein the set of tax rules includes maximum tax and double tax rules.

13. A computer based method, as set forth in claim 1, including the step of automatically generating an invoice for the tax amount.

14. A computer based method, as set forth in claim 1, wherein the contract characteristics include a product family and a model number for the equipment.

15. A computer based method, as set forth in claim 1, wherein the tax amount includes at least one of a sales tax, a use tax, a rental tax, a maximum tax value and a personal property tax.

16. A computer based method, as set forth in claim 1, wherein the user customer location information includes a zip code.

17. A computer based method, as set forth in claim 1, wherein the set of contract characteristics includes a residual amount due at end of contract.

18. A computer based method, as set forth in claim 1, wherein the set of contract characteristics includes a purchase price of the equipment.

19. A computer based method, as set forth in claim 1, wherein the set of contract characteristics includes a type of purchase option.

20. A computer based method, as set forth in claim 19, wherein the type of purchase option is one of fair market value, CMV, a bargained price, and none.

21. A computer based method, as set forth in claim 1, wherein the set of contract characteristics include a mandatory final payment.

22. A computer based method, as set forth in claim 1, wherein the set of contract characteristics include a trade-in.

23. A computer based method for automatically determining taxes for a contract for equipment, including the steps of:
establishing a set of contract characteristics;
establishing customer location information;
automatically determining an appropriate set of tax rules to apply as a function of the customer location information;
determining a contract type based on the contract characteristics under the set of tax rules;
calculating a tax amount based on the contract characteristics, the contract type, and the set of tax rules; and,
generating an invoice for the tax amount.

24. A computer based system for automatically determining taxes for a contract for equipment, comprising:
a database for storing a set of state and local tax rules;
a controller coupled to the database and being adapted to receive a set of contract characteristics and the customer location information and automatically determine an appropriate set of tax rules to apply as a function of the customer location information, to determine a contract type based on the contract characteristics under the set of tax rules, and to calculate a tax amount based on the contract characteristics, the contract type, and the set of tax rules.

25. A computer based system, as set forth in claim 24, wherein the contract type is one of a lease and a financing contract.

26. A computer based system, as set forth in claim 24, wherein the contract type is one of an operating lease, a true lease, a finance option lease, a finance lease purchase with mandatory final payment, a government lease purchase and an installment sale.

27. A computer based system, as set forth in claim 24, wherein the set of tax rules include state and local tax rules.

28. A computer based system, as set forth in claim 27, wherein the set of state and local tax rules include special state and/or local rulings.

29. A computer based system, as set forth in claim 28, wherein the special state and/or local rulings are a function of a power output of the equipment.

30. A computer based system, as set forth in claim 28, wherein the special state and local tax rules are a function of the equipment.

31. A computer based system, as set forth in claim 24, wherein the controller (204) is adapted to determine a paying party who will pay the tax amount as a function of the set of tax rules.

32. A computer based system, as set forth in claim 31, wherein the paying party is one of a dealer, a financing company and a customer.

33. A computer based system, as set forth in claim 24, wherein the controller is adapted to determine how the tax amount is to be paid.

34. A computer based system, as set forth in claim 33, wherein the tax amount is to be paid upfront or in a series of payments.

35. A computer based system, as set forth in claim 24, wherein the set of state and local tax rules includes maximum tax and double tax rules.

36. A computer based system, as set forth in claim 24, wherein the controller is adapted to generate an invoice for the tax amount.

37. A computer based system, as set forth in claim 24, wherein the contract characteristics include a product family and a model number for the equipment.

38. A computer based system, as set forth in claim 24, wherein the tax amount includes at least one of a sales tax, a use tax, a rental tax, a maximum tax value and a personal property tax.

39. A computer based system, as set forth in claim 24, wherein the user customer location information includes a zip code.

40. A computer based system, as set forth in claim 24, wherein the set of contract characteristics includes a residual amount due at end of contract.

41. A computer based system, as set forth in claim 24, wherein the set of contract characteristics includes a purchase price of the equipment.

42. A computer based system, as set forth in claim 24, wherein the set of contract characteristics includes a type of purchase option.

43. A computer based system, as set forth in claim 42, wherein the type of purchase option is one of fair market value, CVO, a bargained price, and none.

44. A computer based system, as set forth in claim 24, wherein the set of contract characteristics include a mandatory final payment.

45. A computer based system, as set forth in claim 24, wherein the set of contract characteristics include a trade-in.

46. A computer based system for automatically determining taxes for a contract for equipment, comprising:
a database for storing a set of state and local tax rules; and,
a controller coupled to the database and being adapted to receive a set of contract characteristics and the customer location information input by a user and automatically determine an appropriate set of tax rules to apply as a function of the customer location information, to determine a contract type based on the contract characteristics under the set of tax rules, the contract type being one of a lease and a financing contract, to calculate a tax amount based on the contract characteristics, the contract type and the set of tax rules, and to generate an invoice for the tax amount.

47. A computer program product for automatically creating a list of financing documents for a transaction, the computer program product, comprising:
computer readable program code means for receiving a set of contract characteristics input by a user;
computer readable program code means for receiving customer location information input by the user;
computer readable program code means for automatically determining an appropriate set of tax rules to apply as a function of the customer location information;
computer readable program code means for determining a contract type based on the contract characteristics under the set of state and local tax rules; and,
computer readable program code means for calculating a tax amount based on the contract characteristics, the contract type and the set of tax rules.
